(19) United States
(12) Patent Application Publication
(10) Pub. No.: US 2017/0133860 A1
(43) Pub. Date: May 11, 2017

(54) System And Method Of Wireless Power Transfer Without Data Communication Channel

(71) Applicant: Korea Advanced Institute of Science and Technology, Daejeon (KR)

(72) Inventors: Sang-Gug Lee, Daejeon (KR); Ngan Hoang, Daejeon (KR); Guillaume Thenaisie, Daejeon (KR); Jeong-Seon Lee, Daejeon (KR)

(21) Appl. No.: 15/014,052

(22) Filed: Feb. 3, 2016

(30) Foreign Application Priority Data
Nov. 10, 2015 (KR) 10-2015-0157659

(51) Int. Cl. H02J 5/00; H02J 50/90; H02J 50/12

(52) U.S. Cl. CPC H02J 5/005; H02J 50/12; H02J 50/90

(57) ABSTRACT

For wireless power transfer, an energy field is formed by a power transmitter in a space near a transmission coil to provide a transmission power in the space of the energy field. A transferred power is receiver by a power receiver through a reception coil in the space of the energy field. An amount of the transferred power is reduced by the power receiver by performing a regulating operation using a switching frequency when the transferred power is excessive. The power transmitter detects a switching frequency signal having the switching frequency that is induced in the transmission coil when the power receiver performs the regulating operation. The power transmitter controls adjustment of the transmission power in response to the detection of the switching frequency signal. The transmission power is adjusted without a data communication for adjustment of the transmission power between the power transmitter and the power receiver.

### CROSS-REFERENCE TO RELATED APPLICATION

This U.S. Non-provisional application claims priority under 35 USC §119 to Korean Patent Application No. 10-2015-0157659, filed on Nov. 10, 2015, in the Korean Intellectual Property Office (KIPO), the disclosure of which is incorporated by reference in its entirety herein.

### BACKGROUND

1. Technical Field

Example embodiments relate generally to wireless power transfer, and more particularly to systems and methods of wireless power transfer capable of adjusting a transmission power by detecting a switching frequency in a power transmitter without a data communication channel between the power transmitter and a power receiver for adjustment of the transmission power.

2. Discussion of the Related Art

Electronic devices such as mobile phones, portable music players, laptop computers, tablet computers, peripheral devices for computers, communication devices (e.g., Bluetooth devices), digital cameras, hearing aids, etc. may receive a power from a rechargeable battery. The electronic devices need to be recharged more frequently as the electronic devices are developed to perform various functions requiring more and more power. The electronic devices may be connected to a power source through a physical cable and then be recharged. The cables and similar connectors may be inconvenient and troublesome in some occasions and cause other problems.

Wireless charging systems where the electronic devices may be recharged in a free space without the physical cable may overcome some disadvantages of the cable charging systems. In the wireless charging systems, power transfer efficiency may be degraded when an excessive power higher than a power required in a power receiver is transmitted by a power transmitter and thus significant amount of power is lost. To solve this problem, a data communication channel in addition to a power channel may be provided and the state information of the power receiver may be transferred to the power transmitter through the data communication channel for adjustment of the transmission power in the power transmitter. The structure of the additional data channel may increase the power consumption of the power receiver and thus performance and productivity of the wireless charging system may be degraded.

### SUMMARY

At least one example embodiment of the present disclosure may provide a system of wireless power transfer capable of adjusting a transmission power in response to an operational state of a power receiver without a data communication for the adjustment of the transmission power.

At least one example embodiment of the present disclosure may provide a method of wireless power transfer capable of adjusting a transmission power in response to an operational state of a power receiver without a data communication for the adjustment of the transmission power.

According to example embodiments, a system of wireless power transfer includes a power transmitter and a power receiver. The power transmitter includes a transmission coil and the power transmitter forms an energy field in a space near the transmission coil to provide a transmission power in the space of the energy field. The power receiver includes a reception coil and the power receiver receives a transferred power through the reception coil that is deposited in the space of the energy field and configured to reduce an amount of the transferred power by performing a regulating operation using a switching frequency when the transferred power is excessive. The power transmitter adjusts the transmission power by detecting the switching frequency in the transmission coil without a data communication for adjustment of the transmission power between the power transmitter and the power receiver.

The power transmitter may further include a detector coupled to the transmission coil to detect a switching frequency signal having the switching frequency that is induced in the transmission coil when the power receiver performs the regulating operation, a power generator configured to generate a power signal having a fundamental frequency, a matching circuit coupled between the power generator and the transmission coil for impedance matching, a power adjustor configured to adjust a magnitude of the power signal in response to a control signal and a controller configured to generate the control signal in response to a detection signal from the detector to control the power adjustor.

The switching frequency of the regulating operation in the power receiver may be different from the fundamental frequency of the power signal in the power transmitter.

The detector may include a filter configured to pass the switching frequency signal having the switching frequency.

The controller may include a processor configured to control the power adjustor to increase the transmission power, determine, in response to the detection signal from the detector, whether the transferred power is increased after increasing the transmission power, when the transferred power is increased, control the power adjustor to further increase the transmission power, when the transferred power is not increased, control the power adjustor to decrease the transmission power, determine, in response to the detection signal from the detector, whether the transferred power is unchanged after decreasing the transmission power, when the transferred power is unchanged, control the power adjustor to further decrease the transmission power, when the transferred power is changed, determine whether the transmission power corresponds to an optimum transfer point, when the transmission power is lower than the optimum transfer point, control the power adjustor to increase the transmission power and when the transmission power corresponds to the optimum transfer point, control the power adjustor to quit the adjustment of the transmission power and enter a standby state.

The power receiver may further include a matching circuit coupled to the reception coil for impedance matching, a rectifier configured to rectify an AC signal provided through the matching circuit to generate a rectifier signal, a voltage adjustor configured to adjust a magnitude of the rectifier signal in response to a control signal to generate an output voltage, a controller configured to generate the control signal based on the output voltage to control the voltage adjustor such that the output voltage is reduced when the transferred power is higher than a power required in the power receiver.

The voltage adjustor may include a pulse-width-controlled switching regulator configured to pass the rectifier signal as the output voltage in response to the control signal when the transferred power is lower than the power required in the power receiver and control a pulse width of a pulse-width signal in response to the control signal and regulate the rectifier signal to reduce the output voltage in response to the pulse-width signal when the transferred power is higher than the power required in the power receiver.

The controller may include a processor configured to receive the output voltage as a feedback signal and control the voltage power adjustor to reduce the pulse width of the pulse-width signal when the transferred power is higher than the power required in the power receiver.

According to example embodiments, a method of wireless power transfer in a system including a power transmitter and a power receiver, includes, forming, by the power transmitter, an energy field in a space near a transmission coil in the power transmitter to provide a transmission power in the space of the energy field, receiving, by the power receiver, a transferred power through a reception coil in the power receiver that is deposited in the space of the energy field, reducing, by the power receiver, an amount of the transferred power by performing a regulating operation using a switching frequency when the transferred power is excessive, detecting, by the power transmitter, a switching frequency signal having the switching frequency that is induced in the transmission coil when the power receiver performs the regulating operation and controlling, by the power transmitter, adjustment of the transmission power in response to the detection of the switching frequency signal. The transmission power is adjusted without a data communication for adjustment of the transmission power between the power transmitter and the power receiver.

Controlling the adjustment of the transmission power may include controlling a power adjustor in the power transmitter to increase the transmission power, determining, in response to a detection signal from the detector, whether the transferred power is increased after increasing the transmission power, when the transferred power is increased, controlling the power adjustor to further increase the transmission power, when the transferred power is not increased, controlling the power adjustor to decrease the transmission power, determining, in response to the detection signal from the detector, whether the transferred power is unchanged after decreasing the transmission power, when the transferred power is unchanged, controlling the power adjustor to further decrease the transmission power, when the transferred power is changed, determining whether the transmission power corresponds to an optimum transfer point, when the transmission power is lower than the optimum transfer point, controlling the power adjustor to increase the transmission power and when the transmission power corresponds to the optimum transfer point, controlling the power adjustor to quit the adjustment of the transmission power and enter a standby state.

Reducing, by the power receiver, the amount of the transferred power may include receiving an output voltage of a voltage adjustor in the power receiver as a feedback signal and controlling the voltage power adjustor to reduce the output voltage in response to the output voltage when the transferred power is higher than the power required in the power receiver.

The system and method of wireless power transfer according to example embodiments may optimize power efficiency between the power transmitter and the power receiver without the data communication. Since components for the data communications may be removed from the power receiver, the power consumption, the size and the cost of the power receiver may be reduced.

### BRIEF DESCRIPTION OF THE DRAWINGS

Example embodiments of the present disclosure will be more clearly understood from the following detailed description taken in conjunction with the accompanying drawings.

FIG. 1 is an equivalent circuit diagram illustrating a system of wireless power transfer according to example embodiments.

FIG. 2 is a timing diagram illustrating voltage and current of a transmission coil depending on voltage and current of a reception coil.

FIG. 3 is a block diagram illustrating a system of wireless power transfer according to example embodiments.

FIG. 4 is a diagram for describing a power adjustment based on a pulse width by a voltage adjustor in a power receiver.

FIG. 5 is a diagram illustrating a relation between a resonant frequency and a switching frequency that is used in a regulating operation by a power receiver.

FIG. 6 is a block diagram illustrating an example embodiment of a power transmitter included in the system of FIG. 3.

FIG. 7 is a flow chart illustrating power control by a controller included in the power transmitter of FIG. 6.

FIG. 8 is a diagram illustrating a relation between a transmission power and a transferred power according to example embodiments.

### DETAILED DESCRIPTION OF THE EMBODIMENTS

Various example embodiments will be described more fully hereinafter with reference to the accompanying drawings, in which some example embodiments are shown. The present disclosure may, however, be embodied in many different forms and should not be construed as limited to the example embodiments set forth herein. Rather, these example embodiments are provided so that this disclosure will be thorough and complete, and will fully convey the scope of the present disclosure to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

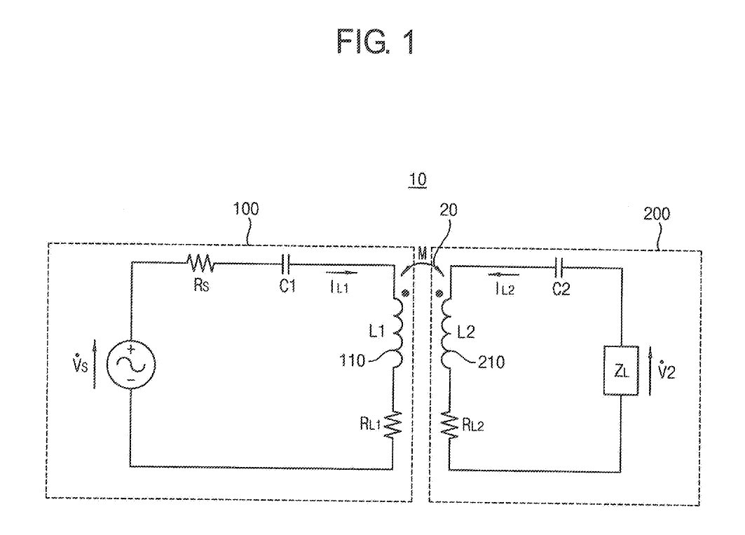

FIG. 1 is an equivalent circuit diagram illustrating a system of wireless power transfer according to example embodiments.

Referring to FIG. 1, a system 10 includes a power transmitter 100 and a power receiver 200.

The power transmitter 100 includes a sinusoidal voltage source Vs and an LC resonator including a transmission coil 110 and a coupling capacitor C1. The sinusoidal voltage source Vs has an equivalent series resistance Rs. The transmission coil 110 has a self-inductance L1 and an equivalent series resistance RL1.

The power receiver 200 includes an LC resonator including a reception coil 210 and a coupling capacitor C2 and an output impedance load ZL. The reception coil 210 has a self-inductance L2 and an equivalent series resistance RL2.

If the mutual inductance of the transmission coil 110 and the reception coil 210 is M, the coupling coefficient k may be calculated as Equation1

$$k = \frac{M}{\sqrt{{L}_{1} {L}_{2}}} \qquad Equation 1$$

Usually the coupling coefficient k is less than 0.2 (scalar) in the LC coupling circuit.

Once the mutual inductance occurs, the voltages VL1 and VL2 across the transmission coil 110 and the reception coil 210 may be obtained respectively by the Faraday's law of inductance as Equation2

$${V}_{L 1} = {L}_{1} \frac{d {I}_{L 1}}{d t} + M \frac{d {I}_{L 2}}{d t} \\ {V}_{L 2} = {L}_{2} \frac{d {I}_{L 2}}{d t} + M \frac{d {I}_{L 1}}{d t} \qquad Equation 2$$

In Equation2, IL1 and IL2 are currents flowing through the transmission coil 110 and the reception coil 210, respectively. Using Laplace transform, Equation3 may be obtained from Equation2.

\dot{V}_{L1}=sL₁İ_{L1}+sM İ_{L2}=\dot{V}₁₁+\dot{V}₁₂

\dot{V}_{L2}=sL₂İ_{L2}+sMİ_{L1}=\dot{V}₂₂+\dot{V}₂₁ Equation3

In Equation3, \dot{A} denotes A∠φ, a polar expression of a complex number, \dot{v}n, (i=1, 2) denotes the induced voltage across the transmission coil 110 and the reception coil 210 due to its own self-inductance Li, and \dot{v}ⱼₖ (j, k=1, 2, j≠k) denotes the induced voltage across the transmission coil 110 and the reception coil 210 respectively due to the mutual inductance M.

The transmission power is the magnetic field power, which is the dot product of the induced voltage in one coil and the current crossing it as Equation4.

$${P}_{12} = - {P}_{21} = ω {MI}_{L 2} {I}_{L 1} cos ( sM {\dot{I}}_{L 2} , {\dot{I}}_{L 1} ) = ω {MI}_{L 2} {I}_{L 1} cos ( - \frac{π}{2} + ( {\dot{I}}_{L 2} , {\dot{I}}_{L 1} ) ) = ω {MI}_{L 2} {I}_{L 1} sin ( {\dot{I}}_{L 2} , {\dot{I}}_{L 1} ) \qquad Equation 4$$

The induced currents may flow the transmission coil 110 and the reception coil 210 by the mutual inductance M between the transmission coil 110 and the reception coil 210, and thus energy may be transferred wirelessly through the electromagnetic field. The transferred energy depends on the induced currents and the mutual inductance.

If the conduction loss due to the equivalent series resistance of the transmission coil 110 and the reception coil 210 are neglected, Equation5 may be obtained by the conversation law of energy.

$${P}_{C 2} = ‖ {\dot{V}}_{C 2} ‖ \cdot ‖ {\dot{I}}_{C 2} ‖ cos ( {\dot{V}}_{C 2} , {\dot{I}}_{C 2} ) = ‖ \frac{{\dot{I}}_{C 2}}{sC} ‖ \cdot ‖ {\dot{I}}_{C 2} ‖ cos ( \frac{{\dot{I}}_{C 2}}{sC} , {\dot{I}}_{C 2} ) = 0 \\ {P}_{21} + {P}_{{Z}_{L}} \approx 0 , \\ {P}_{{Z}_{L}} \approx {P}_{12} \qquad Equation 5$$

Accordingly the output power of the power receiver 200 may be monitored based on the available information (voltage, current) of the transmission coil 110 in the power transmitter 100.

Using Kirchhoff's current law and voltage law, the source voltage Vs of the power transmitter 100 and the output voltage V2 of the power receiver 200 may be obtained as Equation6.

$$\begin{matrix}[ \begin{matrix}{\dot{V}}_{s} \\ {\dot{V}}_{2}\end{matrix} ] = [ \begin{matrix}{R}_{L 1} + {R}_{s} + {sL}_{1} + \frac{1}{{sC}_{1}} & sM \\ sM & {R}_{L 2} + {sL}_{2} + \frac{1}{{sC}_{2}}\end{matrix} ] [ \begin{matrix}{\dot{I}}_{L 1} \\ {\dot{I}}_{L 2}\end{matrix} ] & Equation 6\end{matrix}$$

Equation6 may be rearranged with respect to the coil current IL1 of the transmission coil 110 and the coil current IL2 of the reception coil 210 as Equation7.

$${\dot{I}}_{L 2} = \frac{( {R}_{L 1} + {R}_{s} + {sL}_{1} + \frac{1}{{sC}_{1}} ) {\dot{V}}_{2} - sM {\dot{V}}_{s}}{( {R}_{L 1} + {R}_{s} + {sL}_{1} + \frac{1}{{sC}_{1}} ) ( {R}_{L 2} + {sL}_{2} + \frac{1}{{sC}_{2}} ) - {s}^{2} {M}^{2}} \\ {\dot{I}}_{L 1} = \frac{( {R}_{L 2} + {sL}_{2} + \frac{1}{{sC}_{2}} ) {\dot{V}}_{s} - sM {\dot{V}}_{s}}{( {R}_{L 1} + {R}_{s} + {sL}_{1} + \frac{1}{{sC}_{1}} ) ( {R}_{L 2} + {sL}_{2} + \frac{1}{{sC}_{2}} ) - {s}^{2} {M}^{2}} \qquad Equation 7$$

In Equation7, it may be understood that frequency spectrum of \dot{V}, and \dot{V}₂ are included in the main currents of the power transmitter 100 and the power receiver 200. If the fundamental frequency of \dot{V}₂ is not equal to the coupling frequency, \dot{V}₃=\dot{O}. The current ratio between the power transmitter 100 and the power receiver 200 may be represented as Equation8.

$$\frac{{\dot{I}}_{L 1}}{{\dot{I}}_{L 2}} = \frac{( {R}_{L 2} + {sL}_{2} + \frac{1}{{sC}_{2}} ) {\dot{V}}_{s} - sM {\dot{V}}_{2}}{( {R}_{L 1} + {R}_{s} + {sL}_{1} + \frac{1}{{sC}_{1}} ) {\dot{V}}_{2} - sM {\dot{V}}_{s}} = - \frac{s M}{{R}_{L 1} + {R}_{s} + {sL}_{1} + \frac{1}{{sC}_{1}}} \qquad Equation 8$$

On the other hand, the voltage ratio between the power transmitter 100 and the power receiver 200 at the fundamental switching frequency of \dot{V}₂ may be represented as Equation9.

$$\frac{{\dot{V}}_{L 1}}{{\dot{V}}_{L 2}} = \frac{{sL}_{1} {\dot{I}}_{L 1} + sM {\dot{I}}_{L 2}}{{sL}_{2} {\dot{I}}_{L 2} + sM {\dot{I}}_{L 1}} = \frac{{L}_{1} {\dot{I}}_{L 1} \text{/} {\dot{I}}_{L 2} + M}{{L}_{2} + M {\dot{I}}_{L 1} \text{/} {\dot{I}}_{L 2}} = \frac{{R}_{L 1} + {R}_{s} + \frac{1}{{sC}_{1}}}{\frac{{L}_{2}}{M} ( {R}_{L 1} + {R}_{s} + {sL}_{1} + \frac{1}{{sC}_{1}} ) - sM} \qquad Equation 9$$

As shown in Equation8 and Equation9, the coils' current ratio and voltage ratio are independent of the source voltage Vs of the power transmitter 100 or the output voltage V2 of the power receiver 200. In other words, the current IL1 and the voltage VL1 of the power transmitter 100 vary depending on the current L2 and the voltage VL2 of the power receiver 200, which also depends on the required output power of the power receiver 200. If the output voltage V2 of the power receiver 200 is regulated by the switching frequency Fsw that is different from the coupling frequency between the transmission and the reception coils 110 and 210, the current and the voltage IL2 and VL2 of the power receiver 200 may contain the switching frequency Fsw, and thus the current and the voltage IL1 and VL of the power transmitter 100 may contain the switching frequency Fsw.

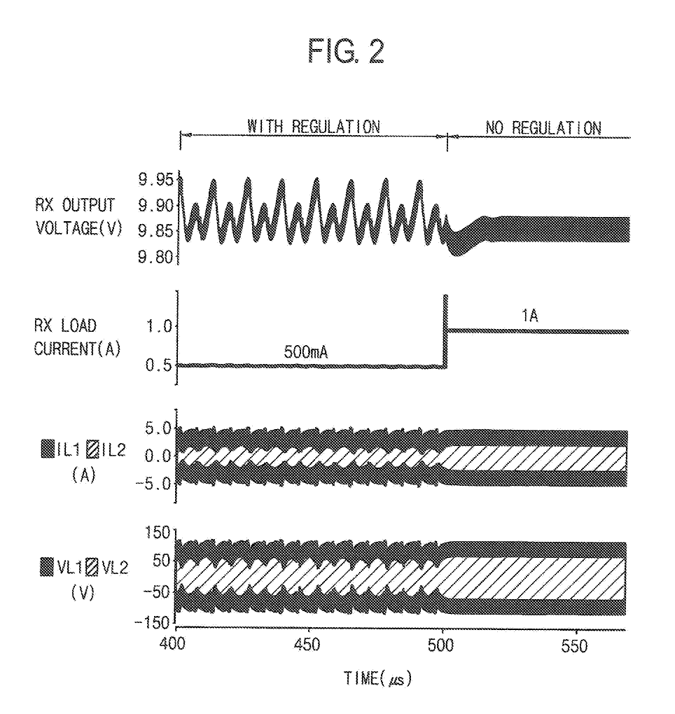

FIG. 2 is a timing diagram illustrating voltage and current of a transmission coil depending on voltage and current of a reception coil.

Referring to FIG. 2, the output voltage of the power receiver (RX) 200 includes the DC component and the resonant frequency when the transferred power is maximized by the load current of 1 A (Ampere) in the power receiver 200. In this case, the electromagnetic interference (EMI) noise may be minimized. When the transferred power is excessive, the output voltage of the power receiver 200 may be regulated by the switching frequency Fsw and the load current may be lowered to 500 mA. As illustrated in FIG. 2, by the regulating operation of the power receiver 200, the switching frequency signal of a superimposed ripple shape may be shown in the voltage VL2 the current IL2 of the power receiver 200 and the voltage VL1 and the current IL1 of the power transmitter 100. Thus the switching frequency may be detected in the transmission coil 110 of the power transmitter 100.

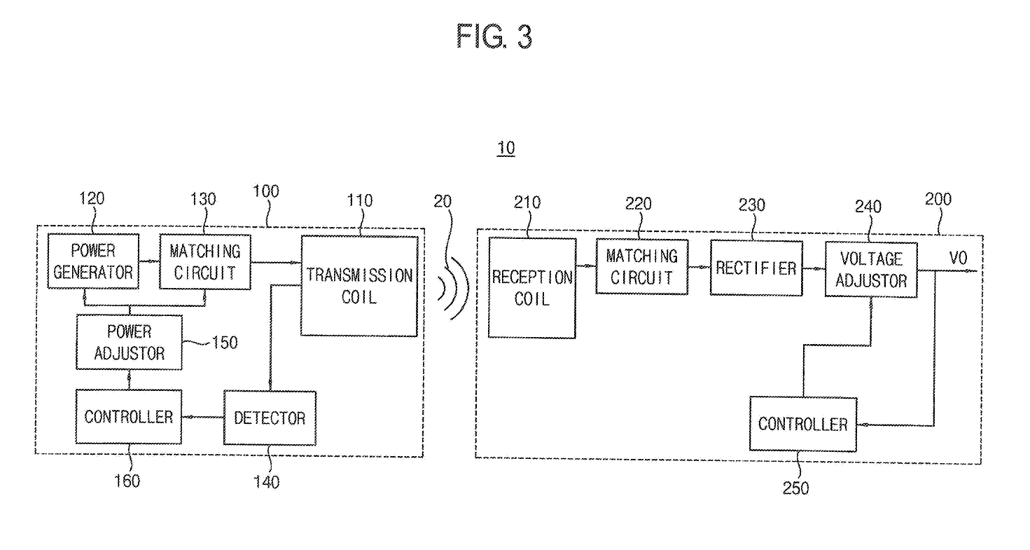

FIG. 3 is a block diagram illustrating a system of wireless power transfer according to example embodiments.

Referring to FIG. 3, a system 10 includes a power transmitter 100 and a power receiver 200. The power transmitter 100 may include a transmission coil 110, a power generator 120, a matching circuit 130, a detector 140, a power adjustor 150 and a controller 160. The power receiver 200 may include a reception coil 210, a matching circuit 220, a rectifier 230, a voltage adjustor 240 and a controller 250.

The power transmitter 100 may form an energy field 20 in a space near the transmission coil 110 to provide a transmission power in the space of the energy field 20. The power transmitter 100 and the power receiver 200 may be separated spatially from each other. The reception coil 210 of the power receiver 200 may be deposited in the space of the energy field 20 to be coupled to the energy field 20. In some example embodiments, the power transmitter 100 and the power receiver 200 may be configured according to a mutual resonance relation. When the resonant frequency of the power receiver 200 is about equal to the resonant frequency of the power transmitter 100, significant energy can be transferred between the power transmitter 100 and the power receiver 200 at a distance. As such, the resonance coupling technique may support the wireless power transfer with various efficiencies depending on the distance between the power transmitter 100 and the power receiver 200 and configurations of the induction coils. The power receiver 200 may receive the transferred power when the power receiver 200 is deposited in the space of the energy field 20. The energy field 20 corresponds to a spatial region that contains the energy from the power transmitter 100, which may be captured by the power receiver 200.

The power transmitter 100 may output the transmission power through the transmission coil 110. The power receiver 200 may receive the transferred power through the reception coil 210 that is coupled to the transmission coil 110 or coupled to the energy field 20. The transferred power received by the power receiver 200 may be lower than the transmission power output by the power transmitter 100. The power may be transferred by the resonant or nearly resonant inductive coupling between the two impedance-matched LC circuits. The power transfer based on the resonant or nearly resonant inductive coupling may provide higher transfer efficiency and the farther transfer distance than the power transfer based on the non-resonant inductive coupling.

The power generator 120 may generate a power signal having a fundamental frequency. For example, the power signal may have the fundamental frequency of 6.78 MHz. The power generator 120 may include a switched power amplifier that drives the transmission coil 110 with the power signal. For example, the switched power amplifier may be a class-E amplifier. The power generator 120 is coupled to the transmission coil 110 through the matching circuit 130. The matching circuit 130 is coupled between the power generator 120 and the transmission coil 110 for impedance matching. The matching circuit 130 may filter out harmonic waves or undesired frequencies in the power signal through the impedance matching. The detector 140 is coupled to the transmission coil 110 to detect the switching frequency signal having the switching frequency that is induced in the transmission coil 110 when the power receiver 200 performs the regulating operation. The detector 140 may provide the detect result to the controller 160. The configuration of the detector 140 will be further described below with reference to FIG. 6.

The power adjustor 150 may adjust a magnitude of the power signal in response to a control signal from the controller 160. For example, the power adjustor 150 may vary the input voltage to the power generator 120, the fundamental frequency of the power signal, the parameters of the matching circuit 130, etc. to adjust the transmission power through the power signal. The controller 160 may generate the control signal in response to the detection signal from the detector 140 to control the power adjustor 150. The controller 160 may optimize the power transfer efficiency based on the detection signal.

The reception coil 210 of the power receiver 200 may receive the transferred power from the transmission power provided by the power transmitter 100. The power receiver 200 according to example embodiments may receive the transferred power based on a resonance scheme, and thus the reception coil 210 may be implemented with a loop coil having a predetermined inductance. The reception coil 210 may receive the transferred power when it is resonated by the electromagnetic field from the power transmitter 100. When the reception coil 210 is implemented with a loop coil, the inductance of the loop coil may be varied and thus the electro-magnetic power of various frequencies may be transferred. In some example embodiments, the reception coil 210 may include a plurality of loop coils. The configuration of the reception coil may not be limited thereto and may be changed variously.

The reception coil 210 may be coupled to the rectifier 230 through the matching circuit 220. The matching circuit 220 may be coupled to the reception coil 210 for impedance matching. The rectifier 230 may rectify an AC signal provided through the matching circuit 220 to generate a rectifier signal.

The voltage adjustor 240 may adjust a magnitude of the rectifier signal in response to a control signal from the controller 250 to generate an output voltage VO. The controller 250 may generate the control signal based on the output voltage VO to control the voltage adjustor 240 such that the output voltage VO may be reduced when the transferred power is higher than a power required in the power receiver 200. The power receiver 200 may reduce an amount of the transferred power by performing the regulating operation using the switching frequency when the transferred power is excessive. For example, the voltage adjustor 240 may adjust the magnitude of the output voltage VO by regulating with the switching frequency between 500 KHz through 3 MHz.

In some example embodiments, the voltage adjustor 240 may include a pulse-width-controlled switching regulator. The switching regulator may pass the rectifier signal as the output voltage VO in response to the control signal from the controller 250 when the transferred power is lower than the power required in the power receiver 200. On the other hand, the switching regulator may control a pulse width of a pulse-width signal in response to the control signal and regulate the rectifier signal to reduce the output voltage in response to the pulse-width signal when the transferred power is higher than the power required in the power receiver 200.

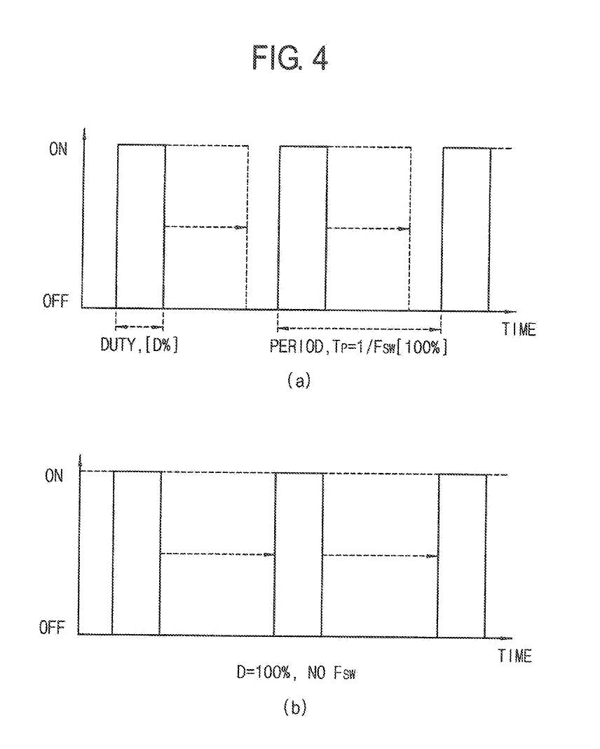

FIG. 4 is a diagram for describing a power adjustment based on a pulse width by a voltage adjustor in a power receiver.

FIG. 4 (a) illustrates a case that the switching signal or the pulse-width signal repeats on and off and the duty ratio of the pulse-width signal having the switching frequency Fsw is varied from D % to 100% when the transferred power is higher than the power required in the power receiver 200. FIG. 4 (b) illustrates a case that the pulse-width signal is the DC signal, that is, the duty ratio of the pulse-width signal is 100% when the transferred power is lower than the power required in the power receiver 200.

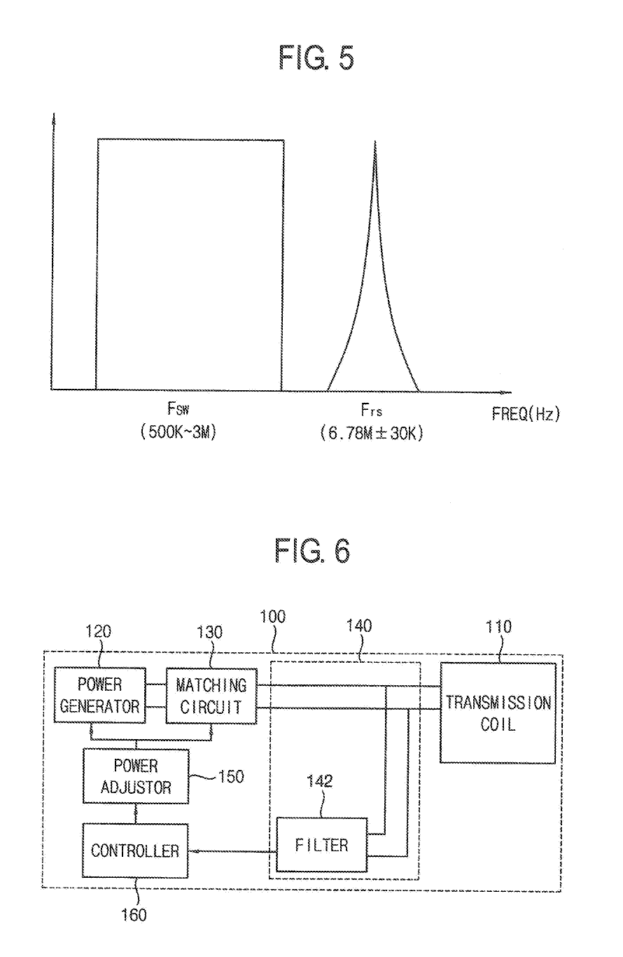

FIG. 5 is a diagram illustrating a relation between a resonant frequency and a switching frequency that is used in a regulating operation by a power receiver.

Referring to FIG. 5, the switching frequency Fsw of the regulating operation in the power receiver 200 may be different from the fundamental frequency or the resonant frequency of the power signal in the power transmitter 100. The controller 250 in the power receiver 200 may be implemented with a processor that receives the output voltage VO as a feedback signal to determine whether the transferred power is adequate. The processor may control the voltage power adjustor 240 to reduce the pulse width of the pulse-width signal when the transferred power is higher than the power required in the power receiver 200.

FIG. 6 is a block diagram illustrating an example embodiment of a power transmitter included in the system of FIG. 3. The configuration is similar to FIG. 3 and the repeated descriptions are omitted.

Referring to FIG. 6, the detector 140 may include a filter 142 configured to pass the switching frequency signal having the switching frequency. The filtered signal may be input to an AC terminal of the controller 160. The filter 142 may be implemented with a band-pass filter for passing only the switching frequency signal having the switching frequency or a low-pass filter for blocking the resonant frequency. The controller 160 may determine the detection of the switching frequency by comparing the filtered signal and a reference signal.

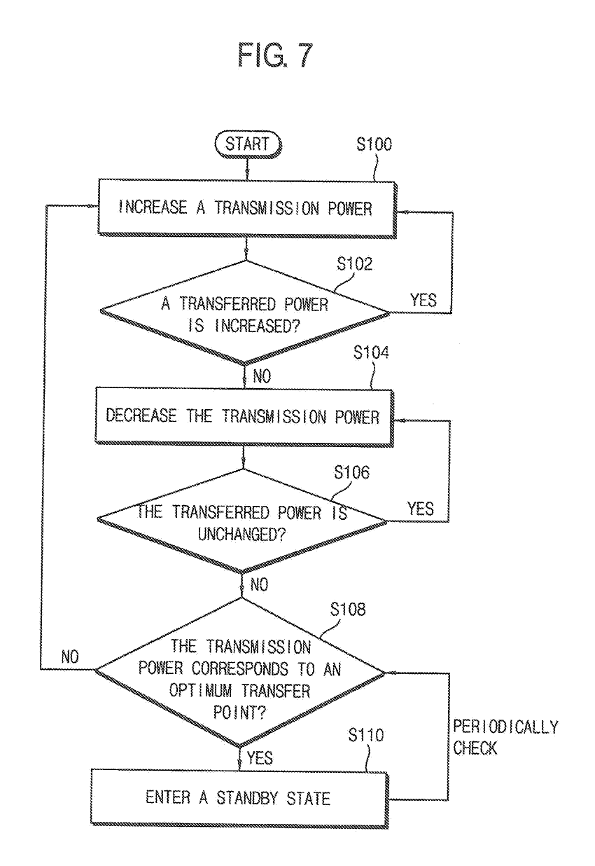

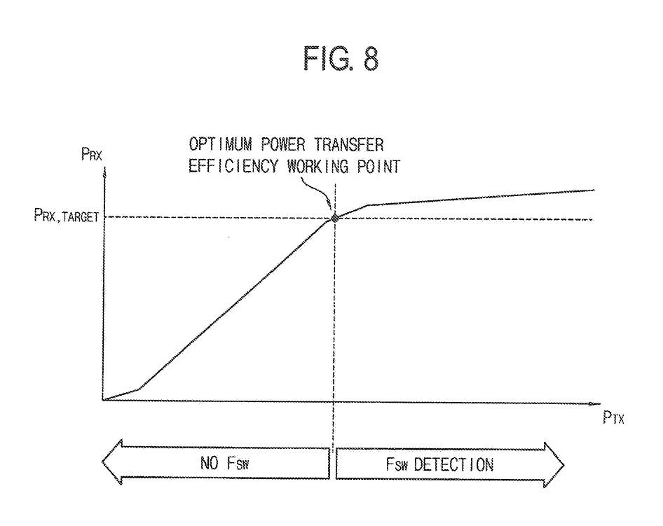

FIG. 7 is a flow chart illustrating power control by a controller included in the power transmitter of FIG. 6, and FIG. 8 is a diagram illustrating a relation between a transmission power and a transferred power according to example embodiments.

The controller 160 in the power transmitter 100 may be implemented with a processor that performs processes as illustrated in FIG. 7. Referring to FIG. 7, the controller 160 controls the power adjustor 150 to increase the transmission power (S100). The controller 160 determines, in response to the detection signal from the detector 140, whether the transferred power is increased (S102) after increasing the transmission power (S100). When the transferred power is increased (S102: YES), the controller 160 controls the power adjustor 150 to further increase the transmission power (S100). As such, the transmission power may be increased repeatedly through S100 and S102 until the transferred power reaches the power required in the power receiver 200. When the transferred power is not increased (S102: NO), the controller 160 controls the power adjustor 150 to decrease the transmission power (S104).

The controller 160 determines, in response to the detection signal from the detector 140, whether the transferred power is unchanged (S106) after decreasing the transmission power (S104). When the transferred power is unchanged (S106: YES) although the transmission power is decreased, the controller 160 controls the power adjustor 150 to further decrease the transmission power because the transferred power is excessive yet. As such, the transmission power may be decreased repeatedly through S104 and S106 until the transferred power reaches an optimum transfer point.

When the transferred power is changed (S106: NO), the controller 160 determines whether the transmission power corresponds to the optimum transfer point (S108). When the transmission power is lower than the optimum transfer point (S108: NO), the controller 160 controls the power adjustor 150 to increase the transmission power (S100). When the transmission power corresponds to the optimum transfer point (S108: YES), the controller 160 controls the power adjustor 150 to quit the adjustment of the transmission power and enter a standby state (S110), with periodically checking for non-optimum transfer condition to repeat the process.

As a result of such control of the controller 160, as shown in FIG. 8, the increasing slope of the transferred power PRX is reduced from the optimum transfer point by the regulating operation of the power receiver 200 even though the transmission power PTX is increased passing through the optimum transfer point. The power transmitter 100 may not increase the transmission power unnecessarily.

As such, the system and method of wireless power transfer according to example embodiments may optimize power efficiency between the power transmitter and the power receiver without the data communication. Since components for the data communications may be removed from the power receiver, the power consumption and the size of the power receiver may be reduced.

Even though the example embodiments are described for wireless power transfer based on the magnetic resonance scheme, it would be understood that the example embodiments may be applied to the wireless power transfer based on the magnetic induction scheme.

The present disclosure may be applied to arbitrary devices and systems adopting the wireless power transfer. For example, the present disclosure may be applied to systems such as be a mobile phone, a smart phone, a personal digital assistant (PDA), a portable multimedia player (PMP), a digital camera, a camcorder, personal computer (PC), a server computer, a workstation, a laptop computer, a digital TV, a set-top box, a portable game console, a navigation system, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A system of wireless power transfer comprising:
a power transmitter including a transmission coil, the power transmitter configured to form an energy field in a space near the transmission coil to provide a transmission power in the space of the energy field; and
a power receiver including a reception coil, the power receiver configured to receive a transferred power through the reception coil that is deposited in the space of the energy field and configured to reduce an amount of the transferred power by performing a regulating operation using a switching frequency when the transferred power is excessive,
wherein the power transmitter is configured to adjust the transmission power by detecting the switching frequency in the transmission coil without a data communication for adjustment of the transmission power between the power transmitter and the power receiver.

2. The system of claim 1, wherein the power transmitter further includes:
a detector coupled to the transmission coil to detect a switching frequency signal having the switching frequency that is induced in the transmission coil when the power receiver performs the regulating operation;
a power generator configured to generate a power signal having a fundamental frequency;
a matching circuit coupled between the power generator and the transmission coil for impedance matching;
a power adjustor configured to adjust a magnitude of the power signal in response to a control signal; and
a controller configured to generate the control signal in response to a detection signal from the detector to control the power adjustor.

3. The system of claim 2, wherein the switching frequency of the regulating operation in the power receiver is different from the fundamental frequency of the power signal in the power transmitter.

4. The system of claim 2, wherein the detector includes a filter configured to pass the switching frequency signal having the switching frequency.

5. The system of claim 2, wherein the controller includes a processor configured to:
control the power adjustor to increase the transmission power;
determine, in response to the detection signal from the detector, whether the transferred power is increased after increasing the transmission power,
when the transferred power is increased, control the power adjustor to further increase the transmission power,
when the transferred power is not increased, control the power adjustor to decrease the transmission power;
determine, in response to the detection signal from the detector, whether the transferred power is unchanged after decreasing the transmission power;
when the transferred power is unchanged, control the power adjustor to further decrease the transmission power,
when the transferred power is changed, determine whether the transmission power corresponds to an optimum transfer point;
when the transmission power is lower than the optimum transfer point, control the power adjustor to increase the transmission power, and
when the transmission power corresponds to the optimum transfer point, control the power adjustor to quit the adjustment of the transmission power and enter a standby state.

6. The system of claim 1, wherein the power receiver further includes:
a matching circuit coupled to the reception coil for impedance matching;
a rectifier configured to rectify an AC signal provided through the matching circuit to generate a rectifier signal;
a voltage adjustor configured to adjust a magnitude of the rectifier signal in response to a control signal to generate an output voltage;
a controller configured to generate the control signal based on the output voltage to control the voltage adjustor such that the output voltage is reduced when the transferred power is higher than a power required in the power receiver.

7. The system of claim 6, wherein the voltage adjustor includes a pulse-width-controlled switching regulator configured to:
pass the rectifier signal as the output voltage in response to the control signal when the transferred power is lower than the power required in the power receiver; and
control a pulse width of a pulse-width signal in response to the control signal and regulate the rectifier signal to reduce the output voltage in response to the pulse-width signal when the transferred power is higher than the power required in the power receiver.

8. The system of claim 7, wherein the controller includes a processor configured to:
receive the output voltage as a feedback signal; and
control the voltage power adjustor to reduce the pulse width of the pulse-width signal when the transferred power is higher than the power required in the power receiver.

9. A method of wireless power transfer in a system including a power transmitter and a power receiver, the method comprising:
forming, by the power transmitter, an energy field in a space near a transmission coil in the power transmitter to provide a transmission power in the space of the energy field;
receiving, by the power receiver, a transferred power through a reception coil in the power receiver that is deposited in the space of the energy field;
reducing, by the power receiver, an amount of the transferred power by performing a regulating operation using a switching frequency when the transferred power is excessive;
detecting, by the power transmitter, a switching frequency signal having the switching frequency that is induced in the transmission coil when the power receiver performs the regulating operation; and
controlling, by the power transmitter, adjustment of the transmission power in response to the detection of the switching frequency signal,
wherein the transmission power is adjusted without a data communication for adjustment of the transmission power between the power transmitter and the power receiver.

10. The method of claim 9, wherein controlling the adjustment of the transmission power includes:
controlling a power adjustor in the power transmitter to increase the transmission power;
determining, in response to a detection signal from the detector, whether the transferred power is increased after increasing the transmission power,
when the transferred power is increased, controlling the power adjustor to further increase the transmission power;
when the transferred power is not increased, controlling the power adjustor to decrease the transmission power;
determining, in response to the detection signal from the detector, whether the transferred power is unchanged after decreasing the transmission power;
when the transferred power is unchanged, controlling the power adjustor to further decrease the transmission power;
when the transferred power is changed, determining whether the transmission power corresponds to an optimum transfer point;
when the transmission power is lower than the optimum transfer point, controlling the power adjustor to increase the transmission power; and
when the transmission power corresponds to the optimum transfer point, controlling the power adjustor to quit the adjustment of the transmission power and enter a standby state.

11. The method of claim 9, wherein reducing, by the power receiver, the amount of the transferred power includes:
receiving an output voltage of a voltage adjustor in the power receiver as a feedback signal; and
controlling the voltage power adjustor to reduce the output voltage in response to the output voltage when the transferred power is higher than the power required in the power receiver.
